(19) United States
(12) Patent Application Publication
(10) Pub. No.: US 2008/0270549 A1
(43) Pub. Date: Oct. 30, 2008

(54) Extracting link spam using random walks and spam seeds

(75) Inventors: Kumar Chellapilla, Redmond, WA (US); Baoning Wu, Pasadena, CA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/789,997

(22) Filed: Apr. 26, 2007

(51) Int. Cl. G06F 17/30; G06F 15/16

(52) U.S. Cl. 709/206; 707/6; 707/E17.001

(57) ABSTRACT

Architecture for extracting link spam communities when given one or more members of the community. A link spam extraction algorithm is provided that takes as input link spam seeds and extracts other nearby link spam through a biased local random walk around the seed(s). The seed set is provided by a user (or an automated algorithm scrubbed by a human) which the algorithm uses to simulate a random walk on a web graph. The random walk can be biased to explore a local neighborhood around the seed set through use of decay probabilities. Truncation can be used to retain only the most frequently visited nodes. After termination, the nodes are sorted in decreasing order of final probabilities and presented to the user. Human judges need only make decisions at the spam community level, thereby limiting involvement, and human input can be scaled by several orders of magnitude.

### BACKGROUND

Online websites receive a significant amount of traffic from search engine referrals. Websites that rank high in search engine results (for some queries) benefit more from search engine referrals than websites that do not. While good web pages rank high due to content and value offered to customers, unethical websites can exploit weaknesses in search engine ranking algorithms to achieve high rankings. Such web pages created unduly attracting search engine referrals are called web spam.

Search engine ranking algorithms can use content and link information to identify good and important websites that are then ranked high. For example, pages where the query terms occur in more important parts of the web page such as title, heading, etc., would be ranked higher than web pages where the query terms occur only in the page footer. Similarly, one indicator of the importance of a web page is the number of other web pages that link to it (through hyperlinks). On average, pages that have a lot of in-links are considered more important that pages that have only a few in-links. Similar to page content, the anchor-text (the content of the hyperlink text used to link to a page) of the page's in-links is considered a valuable source of page content.

Link spamming involves the creation of several pages the link structure (including anchor text) of which is manipulated to rank high in the search engine results. This manipulation can range from simple interlinking of web pages to the generation of complete communities with auto-generated or scraped content and a high level of interlinking among community pages.

Link-exchanges and link-farms are two major types of link spam. Link-exchanges are pairs of web pages that explicitly interlink in order to boost the ranking of the web pages. The page content may contain text that directly invites other web pages to link. In exchange, the page promises to link back. Link-farms, on the other hand, result from two complete websites, or a large group of web pages, that cross-link to each other.

Automatically identifying link spam is a difficult problem. The best conventional link spam detection algorithms generate a non-trivial number of false positives and false negatives. False positives are much more damaging than false negatives. Accordingly, commercial search engines employ manual interaction to more quickly identify and correct these false positives. However, in many cases, even human judgment is subjective and as a result, ambiguous. Consequently, conventional approaches to identifying and eliminating link spam are inadequate.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a directed approach to extracting link spam to find link spam communities when given one or more members of the community as seed. A link spam extraction algorithm is provided that takes as input one or more link spam pages as seeds and extracts other nearby or related link spam pages through a biased local random walk around the seed page. More specifically, in contrast to previous completely automated approaches to finding link spam, one implementation disclosed herein is specifically designed for interactive use. Moreover, the disclosed approach can be used as a post-processing step to resolve ambiguous spam communities.

The disclosed algorithm begins by obtaining a small spam seed set (e.g., one or more link spam pages) provided by a user (or an automated algorithm scrubbed by a human) and simulates a random walk on a web graph. The random walk can be biased to explore a local neighborhood around the seed set through use of decay probabilities. Truncation is used to retain only the most frequently visited nodes. After termination of the process, the nodes are sorted in decreasing order of final probabilities and presented to the user.

With the disclosed algorithm, human judges need only make decisions at the spam community level, thereby limiting involvement, and human input can be scaled by several orders of magnitude.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system for managing spam.

FIG. 2 illustrates a more detailed system for link spam processing in accordance with the disclosed architecture.

FIG. 3 illustrates an exemplary representation of components that can be employed as part of the extraction component for extracting link spam.

FIG. 4 illustrates a method of managing link spam in accordance with the disclosed architecture.

FIG. 5 illustrates a method of manually selecting seed data and truncating spam link lists for constraining the random walk algorithm to neighborhood nodes local to the seed data.

FIG. 6 illustrates a method of detecting a link spam community.

FIG. 7 illustrates a method of employing site data lists to focus the random walking algorithm.

FIG. 8 illustrates a method of adjusting a list of link spam entries based on truncated entries.

FIG. 9 illustrates a method of decaying related link spam based on proximity of related link spam to seed data.

FIG. 10 illustrates a block diagram of a computing system operable to extract link spam and find link spam communities in accordance with the disclosed architecture.

FIG. 11 illustrates a schematic block diagram of an exemplary computing environment for extracting link spam and finding link spam communities in accordance with the disclosed architecture.

### DETAILED DESCRIPTION

The disclosed architecture includes an algorithm for extracting link spam in order to find link spam communities when given one or more members of the community. The algorithm takes as input link spam seeds (e.g., web pages), and extracts other nearby or related link spam through a biased local random walk around the seed(s). The seed set can be provided by a user or an automated algorithm scrubbed by a human which the algorithm uses to simulate a random walk on a web graph. The random walk can be biased to explore a local neighborhood around the seed set through the use of decay probabilities. After process termination, the nodes are sorted in decreasing order of final probabilities and presented to the user. Truncation can be used to retain only the most frequently visited nodes by pruning nodes from the list. Renormalization is provided to compensate for leaf node probability leakage. Human judges need only make decisions at the spam community level, thereby limiting involvement, and human input can be scaled by several orders of magnitude.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

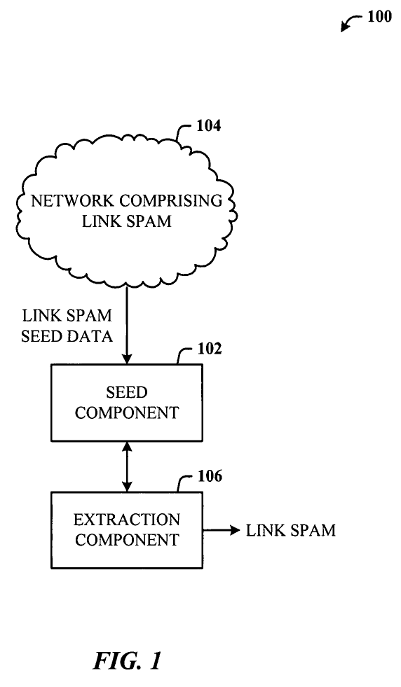

Referring initially to the drawings, FIG. 1 illustrates a computer-implemented system 100 for managing spam. The system 100 includes a seed component 102 for providing seed data associated with link spam. The seed data can be selected manually and/or automatically from a network 104 (e.g., the Internet) that includes link spam (e.g., operational link spam communities). An extraction component 106 is provided as part of the system 100 for extracting the related link spam based on a local random walk relative to the seed data. In other words, given a seed set containing one link spam seed and a web graph, a biased local random walk is applied to extract other members within the same link spam community as the seed data (e.g., website, web page).

The overall effectiveness of the system 100 is significantly improved by retaining human interaction to a limited extent which is removed by conventional automated approaches. The seed data can be provided by a user, or an automated algorithm scrubbed by a human which the algorithm uses to simulate a random walk on a web graph. However, the fact that a human judge picks the seed data (e.g., web page or seed set) significantly improves targeting a specific community, and thus, produces high detection rates and accuracies (the number of false positives produced is very low).

Further, the algorithm generates an ordered list of extracted sites, such that high confidence pages/sites occur higher in the list. For each seed page, the number of extracted pages can range from a few tens to several thousand. This greatly enhancing the ability of a human judge to label web spam pages. The random walk is specially designed to examine the local neighborhood of the seed set, and tuned to extract link spam communities of a desired size.

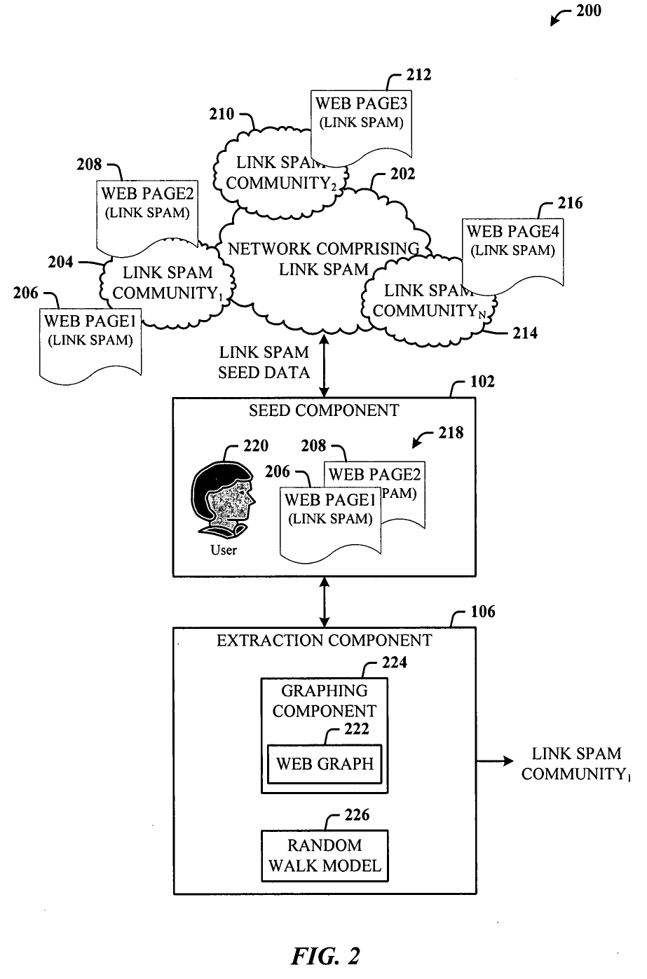

FIG. 2 illustrates a more detailed system 200 for link spam processing in accordance with the disclosed architecture. A network 202 is provided that includes link spam to be searched and determined. The network 202 (e.g., the Internet) includes a plurality of link spam communities such as link farms and/or link exchanges (denoted LINK SPAM COMMUNITY₁, LINK SPAM COMMUNITY₂, . . . , LINK SPAM COMMUNITY_{N}, where N is a positive integer). A goal is to find and identify these spam communities for future avoidance. The spam communities include seed data in the form of one or more web pages. For example, a first spam community 204 includes websites that provide access to a first link spam web page 206 and a second link spam web page 208. Similarly, a second spam community 210 includes a website that provides access to a third link spam web page 212 and a third spam community 214 includes a website that provides access to a fourth link spam web page 216.

The seed component 102 generates seed data 218 via a user 220 manually searching and selecting the link spam web pages (206 and 208). Here, the web pages (206 and 208) happen to be arbitrarily associated with the first link spam community 204 (denoted LINK SPAM COMMUNITY₁). The user 220 selects the web pages (206 and 208) by either manually finding the web pages (206 and 208) which represent tens or hundreds of web page documents, for example, or employing an algorithm that automatically searches and returns the link spam web page documents (206 and 208).

A graphing component 224 generates a web graph 222 of pages and domains. Once the seed data 220 is determined, the extraction component 106 uses the seed data 218 to walk the web graph 222 of nodes and edges, where the nodes represent the web pages and the edges represent a measure of similarity between two connecting web pages. The extraction component 106 also includes a random walk model 226 expressed as an algorithm that randomly walks the web graph 222 to find related link spam (or other members) of the first link spam community 204.

The random walk model is defined as follows. Consider a graph G={V, E} with n=|V| nodes. Let A denote an adjacency matrix of the graph G, and let D be the diagonal matrix where Dᵢᵢ=d(νᵢ), the degree of an i-th vertex. Let S represent a seed set, and s=|S| represents the seed set size. Note that the seed set can be of any size.

The random walk begins with an initial probability distribution p₀, given by

$${p}_{0} ( i ) = \{ \begin{matrix}1 / [ S ] & if i ∈ S , \\ 0 & otherwise\end{matrix}$$

Only the seed node(s) have non-zero probabilities. Then, the probabilities are iteratively updated as the random walk progresses, using

$${p}^{t + 1} = \frac{1}{2} ( I + {AD}^{- 1} ) {p}^{t}$$

The above random walk model simulates the following random web surfer behavior. In other words, when a surfer links into a link spam community via a hyperlink, for example, the probability of exiting the community by selecting another link is low, or put another way, the probability of being trapped in the link community by selecting another link is high. The only way to get out of the community is to manually enter in a new URL (universal resource locator) into the browser. The random walk algorithm leverages this behavior. The user starts from one of the seed nodes, and at each iteration,

(1) with 0.5 probability stays at the current node, and

(2) with 0.5 probability jumps to one of the child nodes with equal probability.

In a directed web graph, jumping to a child node corresponds to clicking on one of the out-links, while in undirected graphs, jumping to a child node corresponds to both content and link structure that can be manipulated simultaneously. Note that the model is also equivalent to the user starting with a seed node, and at each iteration,

(1) with 0.5 probability stays at the current node, and

(2) with 0.5 probability jumps one of the non-zero probability nodes with probability a proportional to the current value.

Intuitively, the nodes within the same link spam community will be assigned higher probability values after several iterations because these nodes are closer to the seed nodes, and are also better connected to other nodes within the same link spam community. Thus, a random surfer will jump to the nodes with a greater likelihood. The nodes that are not within the link spam community will be assigned lower probability values because a random walk algorithm will jump to these nodes from a fewer number of nodes. If iterated over an extended period of time, the probabilities of a connected graph will asymptotically converge to the first Eigen vector of the transition probability matrix, given by

$$T = \frac{1}{2} ( I + {AD}^{- 1} )$$

In consideration of the transient phase, rather than asymptotic convergent probabilities, the node probabilities are good indicators of whether a node belongs to the same spam community as the seed set. Nodes with higher probability are more likely to be part of the spam community than nodes with lower probabilities. Nodes with zero probability are either not part of the spam community or have not yet been discovered.

The random walk model can be modified by changing the composition of the adjacency matrix A in the formula above. By generalizing A from a simple adjacency matrix to a weighted matrix, it is within contemplation of the subject to incorporate extra information about the nodes and edges in the web graph to guide the random walk process. The random walk process follows outgoing edges from a given node with the probability proportional to the edge weight. Examples of useful information include, but are not limited to, node weights based on content spam classifier outputs, edge weights based on topic similarity between pairs of pages, node and edge weights based on user traffic, clicks, dwell-time, etc.

In order to improve the performance of the computation and also bias the random walk towards more promising nodes, truncation can be added to the end of each iteration. The truncation procedure prunes some nodes (e.g., sets corresponding probabilities to zero) from the bottom of a sorted list of probabilities. Pruning can be accomplished in at least two ways. For example, a predetermined fixed threshold can be applied to remove all nodes with a probability value below the threshold. Alternatively, nodes can be dropped with probabilities in a bottom k-percentile of a probability distribution. The latter approach is more dynamic and adapts to communities of different sizes.

In any web graph, leaf nodes (nodes with no children) can leak probability at each iteration. The truncation step also results in a probability leak from the nodes that were pruned. To compensate for this, at the end of each iteration, the probabilities can be renormalized to sum all remaining list entries to a value of one.

Random walks from spam seeds can also lead to reputable sites that are well connected in the network. Known good sites oftentimes have a large fanout and point to many other sites on the network. This can result in an explosive growth in the size of the candidate set every time the random walk encounters a reputed site. The good sites eventually dominate the random walk resulting in community drift. In order to address this problem, a white list of known good sites can be employed. The random walk is modified to not follow any links to white-listed sites. This assumption is reasonable because expansion from spam seed sets and reputable well-known sites are very unlikely to join these link farms or link exchange communities.

Since the members of a link farm or link exchange are expected to have short distances from the seed set, it makes sense to assign a large weight value to the nearby nodes rather than to nodes that are distant from the seed set. Accordingly, a decay algorithm can be employed to constrain the random walk from wandering too far from the seed set. In one example embodiment, the decay probability drop exponentially based on the distance from the seed set. This can be implemented through a probability adjustment step before the truncation step. The probability adjustment step decay each non-zero probability value by an exponential factor based on the distance of the node to the seed nodes, described as follows:

p^{t}[i]=p^{t}[i]×γ[i]

γ[i]=2^{-δ(i)}

where δ(i) is the distance of node i to the seed set. For weighted graphs, this distance can be extended to be the sum of the edge weights along the shortest path. Additionally, the decay can be truncated after a certain distance, for example, the set γ(i)=0, whenever δ(i)>δ>δₘₐₓ.

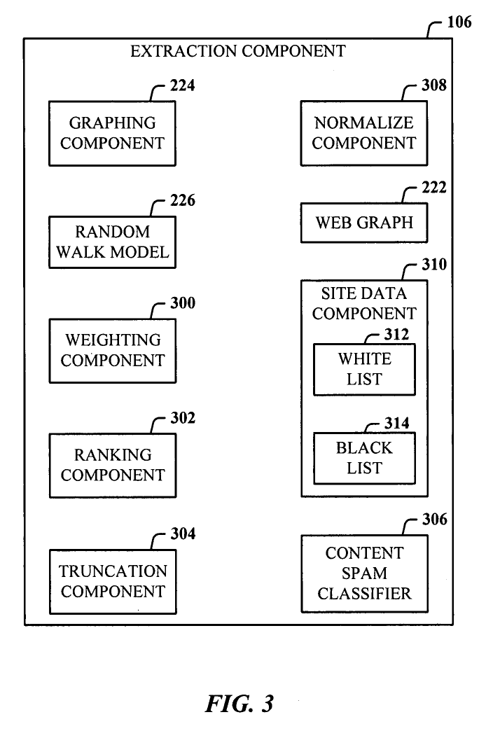

FIG. 3 illustrates an exemplary representation of components that can be employed as part of the extraction component 106 for extracting link spam. The extract component 106 can include the graphing component 224 for generating the web graph 222 based on the seed data. The random walk model 226 executes to walk the web graph 222 to find link spam related to the seed data. A weighting component 300 applies weight values (e.g., probabilities) to the web graph nodes and to the graph edges. Each of the web pages can be assigned weights. Example weights can be a score returned by a content spam classifier 306. Using hyperlinks between web pages, the whole Internet can be viewed as a graph G, where G=(V, E), V is the set of all web pages that comprise vertices, and E is the set of all edges between pairs of web pages.

In such a case, nodes with higher weights can be considered a greater likelihood of being link spam than nodes with lower weights. Similarly, each of the edges can also have associated weights that express similarity between the pages. One way to pick link weights is to assign lower weights to important links between similar pages, and higher weights to unimportant links between unrelated pages. The neighborhood for a web page of size s can be defined to be a set of all web pages within a maximum distance d from the seed page. Note that the distance can be general when weights are involved.

A ranking component 302 generates a list of entries that include link spam nodes and node edges, and ranks the list entries in descending order, for example, according to the probability values. A truncation component 304 then truncates the lower entries of the list as a way to constrain the random walk algorithm to a neighborhood close to the seed data. A normalize component 308 normalizes the remaining entries on the list to a value of one. A site data component 310 provides filtering data for limiting (or focusing) the link spam during the random walk to relevant link spam, based on known good or bad span websites. For example, the site data component 310 can include a white list 312 of known good websites and a black list 314 of known spam websites. Web pages pointed to by white list pages are less likely to be spam. Web pages pointing to and pointed by black list pages are likely to be spam. White listed and black listed sites/pages can also have weights. The weights can be set to be proportional to a degree of participation in link spam.

Following is an exemplary description of the random walk algorithm starting from the seed node. At each step, and from each node with a non-zero probability value (e.g., a 50% chance) jump to one of the children with equal probability, and with a probability value (e.g., a 50% chance), jump to itself (e.g., equivalent jump to another non-zero node in proportion to their current probability value).

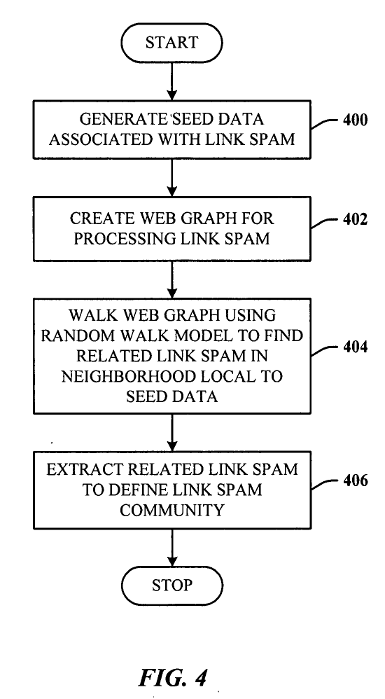

FIG. 4 illustrates a method of managing link spam in accordance with the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 400, seed data associated with link spam is generated. At 402, a web graph is created for processing the seed link spam. At 404, the web graph is walked using a random walk model to find link spam related to the seed link spam in neighborhood local to seed spam. At 406, related link spam is extracted to define the link spam community.

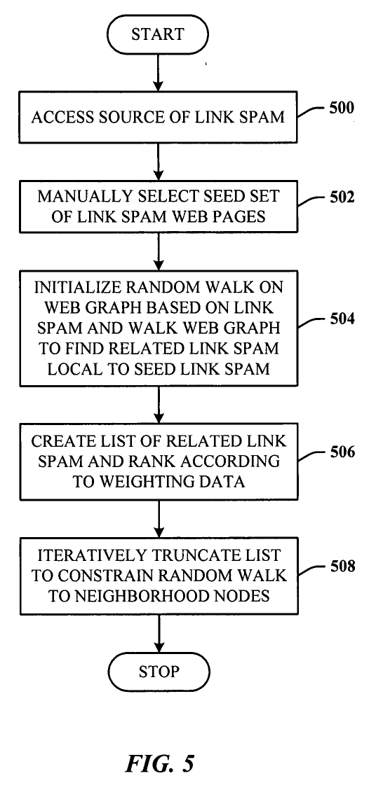

FIG. 5 illustrates a method of manually selecting seed data and truncating spam link lists for constraining the random walk algorithm to neighborhood nodes local to the seed data. At 500, a source of link spam is accessed. The source can be a network such as the Internet. At 502, a user manually selects a seed set of data. This data can include link spam web pages, as subjectively determined by the user. At 504, initialize a random walk on web graph based on the link spam, and the web graph is randomly walked to find related link spam local to the seed link spam. At 506, a list of related link spam is created, and list entries ranked according to weighting data. The weighting data can be probability data applied not only to link spam web page nodes, but also to edges between similar web pages. At 508, the list is truncated to retain only the higher-valued list entries to constrain the random walk algorithm to neighborhood nodes local to the seed set.

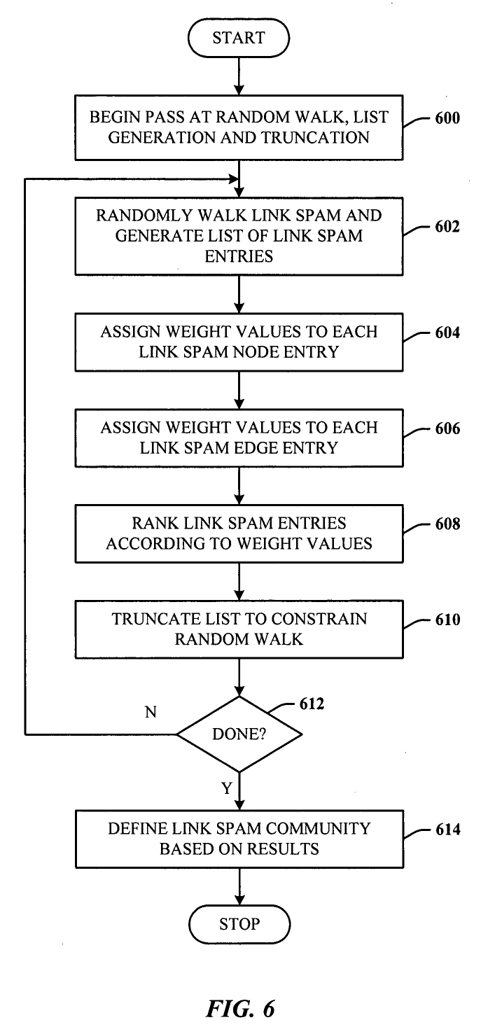

FIG. 6 illustrates a method of detecting a link spam community. At 600, a first pass of a random walk is begun to generate a list of link spam data and truncate the list. At 602, the seed data is randomly walked to find and generate a list of related link spam. At 604, weight values are assigned to the link spam node entries. At 606, weight values are assigned to the link spam edge entries. At 608, the list entries are ranked according to the weight values. At 610, the list is truncated to constrain the random walk algorithm to a neighborhood local to the seed set. At 612, a check is performed to determine if the process is done. If not, flow is back to 602 to continue randomly walking. If done, flow is from 612 to 614 to then define the link spam community based on the results.

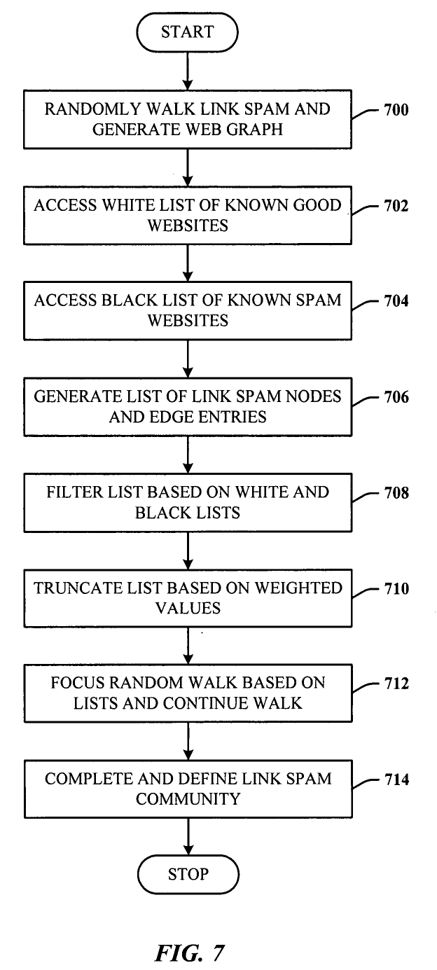

FIG. 7 illustrates a method of employing site data lists to focus the random walking algorithm. At 700, seed link spam is randomly walked and a web graph generated. At 702, a white list of known good websites is accessed. At 704, a black list of known spam websites is accessed. At 706, a list of link spam nodes and edges is generated. At 708, the list is filtered based on the white list and blacklist. At 710, the list is then truncated to remove the lower ranked weighted entries. At 712, the random walk is focused based on the list, and the walk continues. At 714, the walk is completed and a link spam community is defined based on the results.

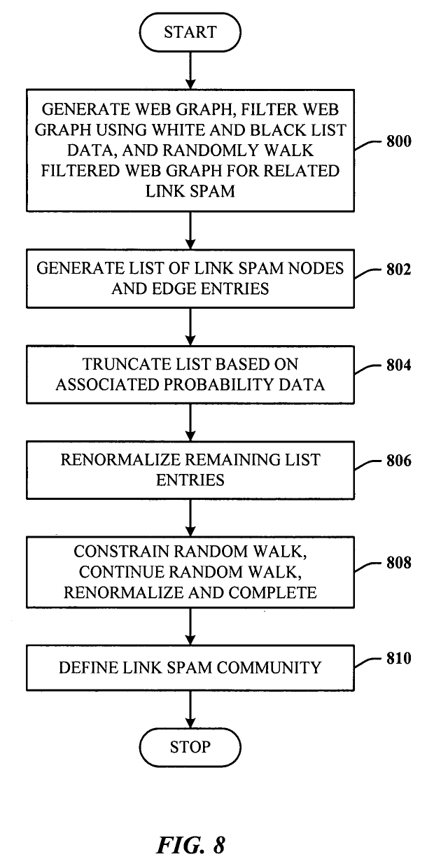

FIG. 8 illustrates a method of adjusting a list of link spam entries based on truncated entries. At 800, a web graph is generated, the graph filtered based on white and black lists, and the web graph walked for related link spam. At 802, a list of link spam entries for nodes and node edges is generated. At 804, the list is truncated based on associated probability data. At 806, the list is renormalized based on the remaining entries. At 808, the random walk is constrained based on the truncated and renormalized list, the walk continues and, truncation and renormalization continues until completed. At 810, the link spam community is defined based on the results.

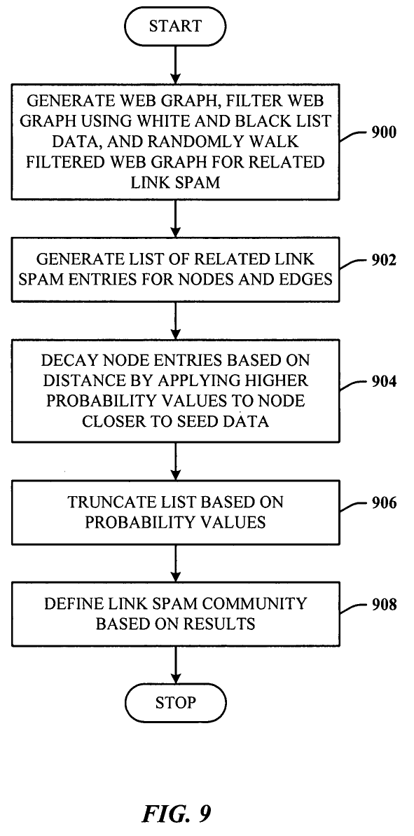

FIG. 9 illustrates a method of decaying related link spam based on proximity of related link spam to seed data. At 900, based on the seed data, a web graph is generated, the graph filtered based on white and black lists, and the web graph walked for related link spam. At 902, a list of link spam entries for nodes and node edges is generated. At 904, node entries of the list are decayed by applying higher probability values to nodes closer to seed data. At 906, the list is then truncated based on the probability values. At 908, the link spam community is defined based on the results.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

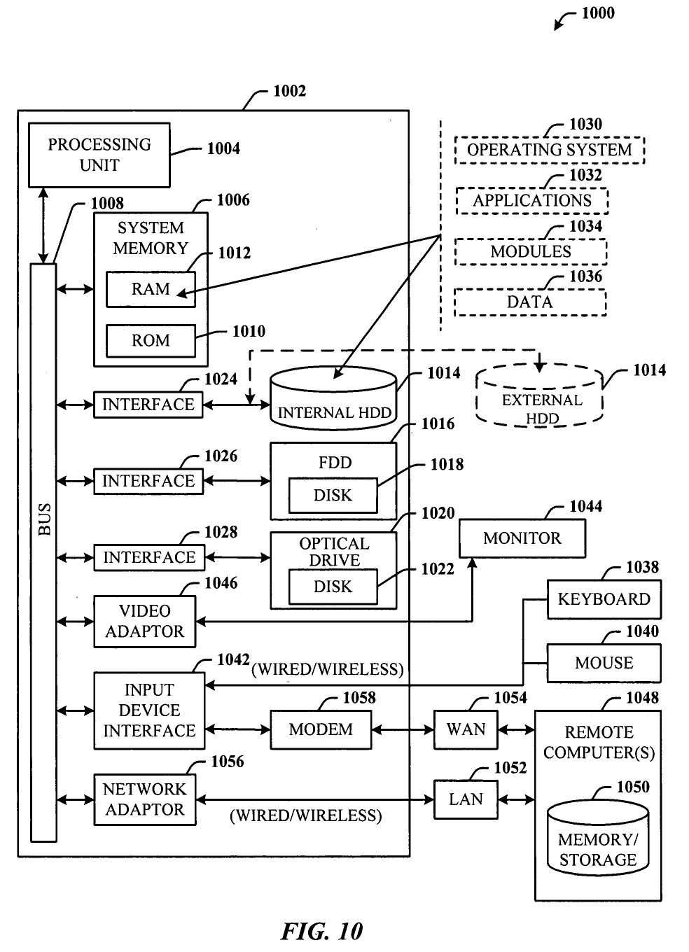

Referring now to FIG. 10, there is illustrated a block diagram of a computing system 1000 operable to extract link spam and find link spam communities in accordance with the disclosed architecture. In order to provide additional context for various aspects thereof, FIG. 10 and the following discussion are intended to provide a brief, general description of a suitable computing system 1000 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 10, the exemplary computing system 1000 for implementing various aspects includes a computer 1002, the computer 1002 including a processing unit 1004, a system memory 1006 and a system bus 1008. The system bus 1008 provides an interface for system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 1012, including an operating system 1030, one or more application programs 1032, other program modules 1034 and program data 1036. The one or more application programs 1032, other program modules 1034 and program data 1036 can include the seed component 102 and extraction component of FIG. 1, the web graph 222, graphing component 224 and random model 226 of FIG. 2, and the components (300, 302, 304, 306, 308, 310, 312 and 314) of FIG. 3, for example.

All or portions of the operating system, applications, modules, and/or data can also be cached in the RAM 1012. It is to be appreciated that the disclosed architecture can be implemented with various commercially available operating systems or combinations of operating systems.

A user can enter commands and information into the computer 1002 through one or more wire/wireless input devices, for example, a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wire and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the local network 1052 through a wire and/or wireless communication network interface or adapter 1056. The adaptor 1056 may facilitate wire or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, for example, computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3 or Ethernet).

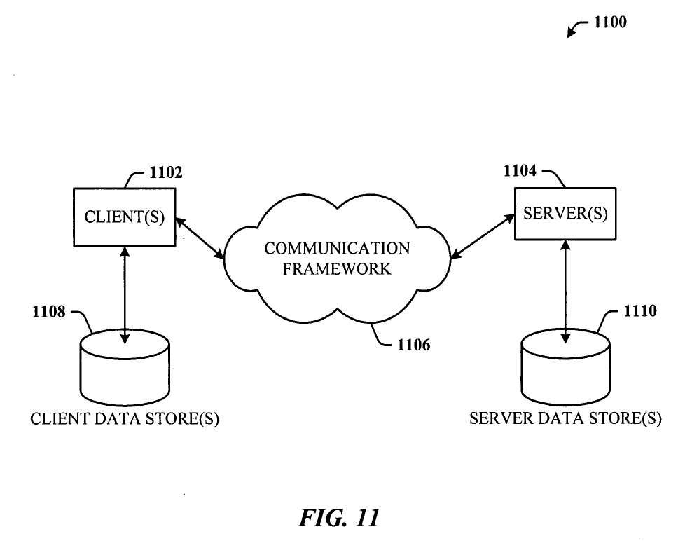

Referring now to FIG. 11, there is illustrated a schematic block diagram of an exemplary computing environment 1100 for extracting link spam and finding link spam communities in accordance with the disclosed architecture. The system 1100 includes one or more client(s) 1102. The client(s) 1102 can be hardware and/or software (e.g., threads, processes, computing devices). The client(s) 1102 can house cookie(s) and/or associated contextual information, for example.

The system 1100 also includes one or more server(s) 1104. The server(s) 1104 can also be hardware and/or software (e.g., threads, processes, computing devices). The servers 1104 can house threads to perform transformations by employing the architecture, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wire (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for managing spam, comprising:
a seed component for providing seed data associated with link spam; and
an extraction component for extracting the link spam based on a local random walk relative to the seed data.

2. The system of claim 1, wherein the seed data is selected manually.

3. The system of claim 1, wherein the link spam is associated with a link spam community that resides on a network.

4. The system of claim 1, further comprising a ranking component for providing an ordered list of web pages of extracted websites and ranking the web pages based on probability data that the pages are link spam.

5. The system of claim 1, wherein the local random walk examines a local neighborhood of link spam relative to the seed data to define a link spam community.

6. The system of claim 1, wherein the local random walk extracts the link spam based on at least one of a white list of known spam-free websites or a black list of known link spam websites.

7. The system of claim 1, further comprising a weighting component for assigning weight data to web pages or a website based on a spam content classifier.

8. The system of claim 1, further comprising a weighting component for assigning weight data to web page edges based on similarity between the web pages.

9. The system of claim 1, wherein the extraction component applies a decay value to constrain the local random walk within a predetermined distance from the seed data.

10. The system of claim 1, further comprising a ranking component for creating a ranked list of link spam after each iteration of the random walk based on associated probability data.

11. The system of claim 10, further comprising a truncation component for truncating entries of the ranked list of link spam based on one of a predetermined threshold or a percentile of a probability distribution.

12. A computer-implemented method of managing spam, comprising:
generating seed data associated with link spam;
creating a web graph for processing the link spam;
walking the web graph using a random walk model to find related link spam in a neighborhood local to the seed data; and
extracting the related link spam to define a link spam community.

13. The method of claim 12, wherein the seed data is a web page that contains link spam, the seed data created at least one of manually or automatically in combination with manual scrubbing.

14. The method of claim 12, further comprising biasing the random walk model to nodes local to the seed data by truncating a list of the related link spam.

15. The method of claim 12, further comprising iteratively truncating a ranked list of the related link spam to focus the local random walk to nodes close to the seed data.

16. The method of claim 15, further comprising renormalizing the truncated list to a value of one.

17. The method of claim 12, further comprising decaying a list of the related link spam by assigning higher probability values to link spam closer in distance to the seed data relative to link spam that is further in distance from the seed data.

18. The method of claim 12, further comprising filtering the web graph based on a white list of known good websites and a black list of known spam websites.

19. The method of claim 12, further comprising extracting the related link spam until a predetermined size of the link spam community is achieved.

20. A computer-implemented system, comprising:
computer-implemented means for generating seed data associated with link spam;
computer-implemented means for creating a web graph to process the link spam;
computer-implemented means for walking the web graph using a random walk algorithm to find related link spam in a neighborhood local to the seed data; and
computer-implemented means for extracting the related link spam to define a link spam community.
